(19) United States
(12) Patent Application Publication
(10) Pub. No.: US 2013/0167362 A1
(43) Pub. Date: Jul. 4, 2013

(54) PREPARATION METHOD OF LITHIUM RECHARGEABLE BATTERY COMPOSITE ANODE FROM SILICON KERF

(71) Applicants: Wanli XU, Baton Rouge, LA (US); John T. FUSSELL, Baton Rouge, LA (US)

(72) Inventors: Wanli XU, Baton Rouge, LA (US); John T. FUSSELL, Baton Rouge, LA (US)

(73) Assignee: Electrochemical Materials, LLC, Baton Rouge, LA (US)

(21) Appl. No.: 13/653,549

(22) Filed: Oct. 17, 2012

(51) Int. Cl. H01M 4/04

(52) U.S. Cl. CPC H01M 4/04
USPC 29/623.1

(57) ABSTRACT

The disclosure generally describes a method to prepare a composite anode for a lithium rechargeable battery comprising silicon particles from silicon kerf. Said silicon particles are mechanically resized, separated, cleaned, mixed with carbonaceous materials and polymer binder, and formed into an anode for a lithium rechargeable battery. The lithium rechargeable battery featuring such an anode exhibits an exceptionally high specific capacity, an excellent reversible capacity, and a long cycle life.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

1. Field of Invention

The present invention generally relates to a method to prepare a composite anode for a lithium rechargeable battery using silicon particles from silicon kerf.

2. Description of the Related Art

Rechargeable lithium batteries are commonly used in portable electronic devices such as cell phones, tablet computers, and laptop computers and are also used in electric vehicles. Conventional batteries are made using spinel cathodes and graphite anodes and battery capacities are limited to approximately 100 mAh·g⁻¹. There is considerable interest in new electrode materials that would increase the capacity of lithium rechargeable batteries.

Silicon has become a promising candidate to replace graphite as an anode material for lithium rechargeable batteries. Silicon has a theoretical capacity for lithium storage of 4200 mAh·g⁻¹, which is over ten times higher than that of conventional graphite. An important concern centers on the composition, size and shape of silicon that could be used to produce a high-capacity anode.

There are many methods to create silicon anodes using various sources of silicon. Silicon anodes may be made using solely silicon as the active material or silicon may be combined with other active materials such as graphite to form composite anodes. Silicon-only anode materials such as nanowires, nanofilms, or other nanostructures are typically created by vapor deposition process such as chemical vapor deposition (CVD) using silanes precursors such as SiH.sub.4. Silicon in composite anodes typically originates from growth methods such as CVD or solution growth or from subtractive methods such as laser ablation, etching, or mechanical attrition. In general, the aforementioned methods of producing silicon are relatively expensive and the resulting materials may not be ideally suited for use in anodes due to their size, shape, purity or composition, and surface chemistry.

Currently, about 80% of the initial metallurgical-grade silicon material is wasted during the process of making silicon solar cells or wafers. After a silicon ingot is grown, it is sliced into wafers in a sawing process. Sawing with multiple wiresaws is now the preferred method used to slice silicon ingots. Wiresaw technology can produce wafers as thin as 200 micrometer; however, a layer of silicon about 250 to 280 micrometers thick is typically lost as kerf for each wafer produced. Depending on wafer thickness, kerf loss represents from 25% to 50% of the silicon ingot material. The silicon kerf is difficult to recycle due to the presence of solvents, oils, other impurities such as silicon carbides, and the native oxide at the surface of waste silicon particles.

Silicon kerf is difficult to use directly as lithium-ion batteries since key parameters such as silicon particle size, surface oxides, and impurities, do not fulfill the requirements for silicon anode materials.

As described in U.S. Pat. No. 8,034,313 and U.S. Pat. No. 8,231,006, it is possible to recover silicon byproducts, such as kerf or silicon slurry generated from semiconductor manufacturing process. The waste silicon may be processed for use in solar cells.

U.S. Pat. No. 6,780,665 describes methods of centrifuging, decanting, filtration, froth flotation and high energy electrical discharge techniques to recover crystalline silicon metal kerf from wire saw slurries for use in solar cells.

U.S. Pat. No. 6,838,074 describes methods of centrifuging, decanting, filtration, froth flotation and high energy electrical discharge techniques to recover crystalline silicon metal kerf from wire saw slurries for use in microelectromechanical systems (MEMS).

Due to the demand for higher capacity batteries and a valuable source of silicon, a method to recycle the byproducts such as kerf or polishing waste to create anodes for lithium rechargeable batteries would be extremely desirable. Thus, there exists great value in recovering silicon kerf, processing the kerf, and using the processed silicon particles in a lithium rechargeable battery anode.

### SUMMARY OF THE INVENTION

In another embodiment of the present invention, a method to prepare a composite anode for use in a lithium rechargeable battery using silicon particles from silicon kerf.

### BRIEF DESCRIPTION OF THE DRAWING

FIG. 1 is an SEM image of silicon particles from silicon kerf before resizing.

FIG. 2 is an SEM image of silicon particles from silicon kerf after resizing and separation.

FIG. 3 is the charge/discharge performance of a lithium-ion cell containing a silicon composite anode, comprising silicon particles from silicon kerf.

### DETAILED DESCRIPTION OF THE INVENTION

The present invention is believed to be applicable to a variety of different types of lithium rechargeable batteries and devices and arrangement involving silicon composite electrodes. While the present invention is not necessarily limited, various aspects of the invention may be appreciated through a discussion of examples using the context.

In one embodiment of the present invention, a method to prepare an anode for use in a lithium rechargeable battery using silicon particles from silicon kerf, consisting of (a) restricting the sizes of said silicon particles to a range of 10 nanometers and 10 micrometers with a preferred range from 50 nanometers to 500 nanometers, with a more preferred range from 100 nanometers to 300 nanometers, (b) separating said silicon particles from silicon kerf, (c) cleaning said silicon particles, and (d) forming said silicon particles with a restricted size into a composite matrix and attaching said composite matrix to a current collector for use as an anode in a lithium rechargeable battery.

The composite anode is comprised of silicon particles from silicon kerf, carbonaceous materials, and polymer binder. Silicon kerf is comprised of silicon particles, silicon carbide particles, organic solvents such as glycols, and other impurities. Silicon particles in silicon kerf are in micrometers scale (FIG. 1). Silicon particles from silicon kerf are formed into a composite matrix with carbonaceous materials, and polymer binder to use as an anode for a lithium rechargeable battery.

Said silicon particles from silicon kerf have a size range from 10 nanometers to 10 micrometers with a preferred range from 50 nanometers to 500 nanometers, with a more preferred range from 100 nanometers to 300 nanometers. Weight percent of said silicon particles is ranging from 0.5% to 50% with a preferred range from 5% to 40%, with a more preferred range from 15% to 30% based on the weight of the composite anode.

Said silicon particles from kerf include silicon carbide. Silicon particles include dopants such boron, phosphorous, arsenic, or antimony, and combinations thereof.

Said silicon particles from silicon kerf are resized mechanically. Silicon particles present in silicon kerf is ranging from several micrometers to over 100 micrometers (FIG. 1). The average silicon particle diameter may be decreased by milling silicon kerf in milling media. Examples of the milling media are, but are not limited to, alumina, silica, chrome, tungsten, stainless steel balls, as well as other ceramic and metal milling medias, wherein the effective diameter of the milling media used in ball mill is ranging from 1 millimeter to 20 millimeters, with a preferred diameter of 4 to 6 millimeters. Volumetric ratio of stainless steel balls used in ball mill to the milling material ranges from 10:1 to 1:1, with a preferred ratio of 4:1. The milling process can be carried out in a batch or continuous process with recycling.

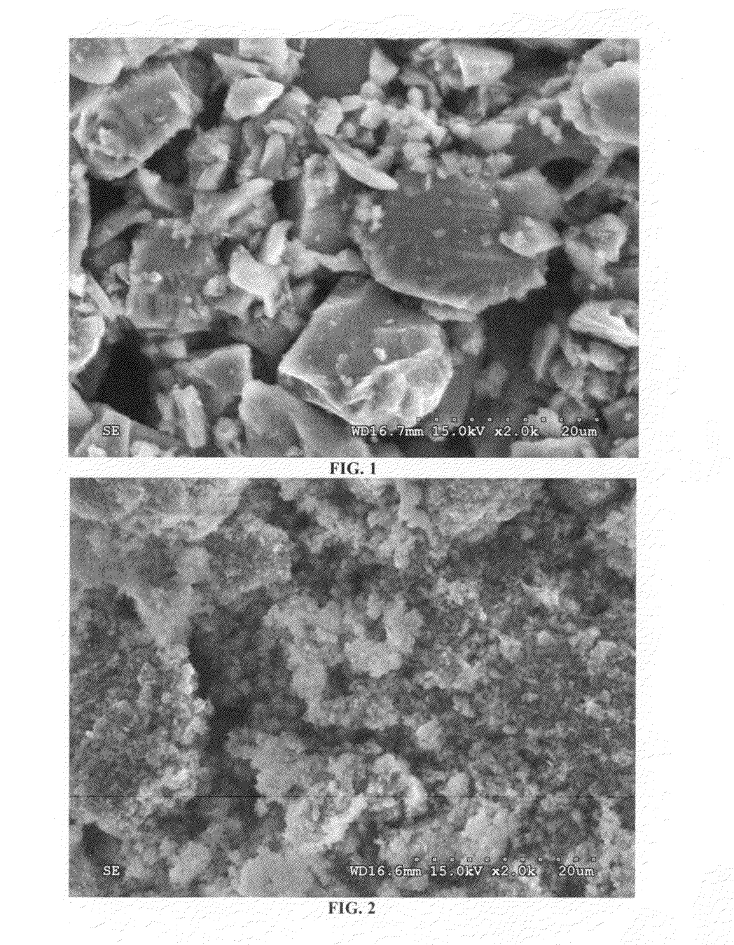

Said silicon particles are separated from silicon kerf using filtration. In one embodiment, a liquid slurry may be filtered using filters with desirable pore sizes. Smaller particles are allowed to pass across the filter while larger particles remain unfiltered. Said silicon particles obtained from abovementioned filtering process have diameter less than 500 nanometers, preferably less than 300 nanometers (FIG. 2). The larger unfiltered particles may be recycled to the milling process.

Said silicon particles are separated from silicon kerf using centrifugation. After resizing, silicon kerf is fed into a bowl centrifuge for separation. The bowl and lagging scroll rotate at a high speed in the same direction. The slurry is conveyed through the centrifuge feed pipe and inlet ports in the scroll body into the bowl and accelerated to the bowl speed. Centrifugal force causes the solids which are heavier than the carrier liquid to settle against the bowl wall. The scroll conveys the deposited layer of heavy solids toward the conical bowl section, over the drying zone and ejects them through ports into the stationary solids housing and down the discharge chute. The solids which are lighter than the carrier liquid float and are conveyed with the liquid toward the cylindrical end of the bowl. When the floating particles have reached the second inner cone, scroll flights wound in the opposite direction to those conveying sedimentated solids transfer the lighter solids across a drying zone to the exit ports. The liquid is skimmed off and discharged under pressure by an impeller at the cylindrical end of the bowl. The liquid and larger particles may be recycled.

Said silicon particles are cleaned or chemically treated to remove impurities or surfaces oxides. Cleaning agents such a surfactants, complexing agents, acids, oxidizing agents, or bases may be used to remove unwanted impurities from silicon particle surfaces. Chemical treatments such as dilute hydrofluoric acid may be used to remove the native oxide present at silicon particle surfaces.

Said silicon particles can be formed into a composite matrix with carbonaceous materials, and polymer binder for use as an anode for lithium rechargeable battery. Weight percent of said silicon particles is ranging from 0.5% to 50% with a preferred range from 5% to 50%, with a more preferred range from 10% to 30% based on the weight of active materials in the composite. The carbonaceous materials may be obtained from various sources, examples of which may include but not limited to petroleum pitches, coal tar pitches, petroleum cokes, flake coke, natural graphite, synthetic graphite, soft carbons, as well as other carbonaceous material that are known in the manufacture of prior art electrodes, although these sources are not elucidated here. The polymer binder may be, but not limited to, polyvinylidene fluoride, sodium carboxymethyl cellulose, styrene-butadiene rubber, and etc. The composite matrix comprising silicon particles from silicon kerf, carbonaceous materials, and polymer binder can be attached to a current collector. The current collector can be metallic copper film with a preferred thickness of 10 micrometers to 100 micrometers. In this fashion, the arrangement can be used as an anode in a lithium rechargeable battery.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

### EXAMPLES

While embodiments have been generally described, the following examples demonstrate particular embodiments in practice and advantage thereof. The examples are given by way of illustration only and are not intended to limit the specification or the claims in any manner. The following illustrates exemplary details as well as characteristics of such surface modified silicon particles as the active anode materials for lithium rechargeable batteries.

In this example, 100 grams of silicon kerf slurry (approximately 50 vol. % diameter larger than 2 micrometers and approximately 50 vol. % diameter ranging from 0.5 micrometer to 100 nanometers) can be mixed with 100 milliliters of anhydrous methanol as co-solvent in a 2 liters ceramic ball mill container with 75 grams of stainless balls (average diameter 4 millimeters). The resulting mixture is milled for 8 hours at 25 degree Celsius.

The resulting slurry was filtered using filter paper with a filtration membrane (pore size of 500 nanometers). Said silicon particles obtained from abovementioned process have diameter less than 500 nanometers, and approximately 10 grams of silicon particles is obtained from the process.

Approximately 0.5 grams of the recovered silicon particles were cleaned using 10 milliliters of 1% hydrofluoric acid aqueous solution, followed by rinsing with 10 milliliters of de-ionized water for three times. The silicon particles were heated at 75 degrees Celsius until completely dry under argon atmosphere.

The cleaned particles were well mixed with 0.5 grams of carbon black (average particle size below 50 nanometer), 3.5 grams of natural graphite (average particle size below 40 micrometer), and 10 milliliters 5 wt. % polyvinylidene fluoride in n-methylpyrrolidone solution (equivalent to 0.5 grams of polyvinylidene fluoride). The resulting mixture was applied to a copper foil (˜25 micrometers thick) using the doctor blade method to deposit a layer of approximately 100 micrometers. The film is then dried in vacuum at 120 degree Celsius for 24 hours.

The resulting anode was assembled and evaluated in lithium secondary coin cell CR2032 with lithium cobalt oxide as the other electrode. A disk of 1.86 cm² was punched from the film as the anode, and the anode active material weight is approximately 5 micrograms. The other electrode was a lithium cobalt oxide cathode with a thickness of 100 micrometers and had the same surface area as the anode. A microporous trilayer polymer membrane was used as separator between the two electrodes. Approximately 1 milliliter 1 molar LiPF.sub.6 in a solvent mix comprising ethylene carbonate and dimethyl carbonate with 1:1 volume ratio was used as the electrolyte in the lithium cell. All above experiments were carried out in glove box system under an argon atmosphere with less then 1 part per million water and oxygen.

The assembled lithium coin cell was removed from the glove box and stored in ambient conditions for another 24 hours prior to testing. The coin cell was charged and discharged at a constant current of 0.5 mA, and the charge and discharge rate is approximately C/5 from 2.75 V to 4.2 V versus lithium for over 100 cycles.

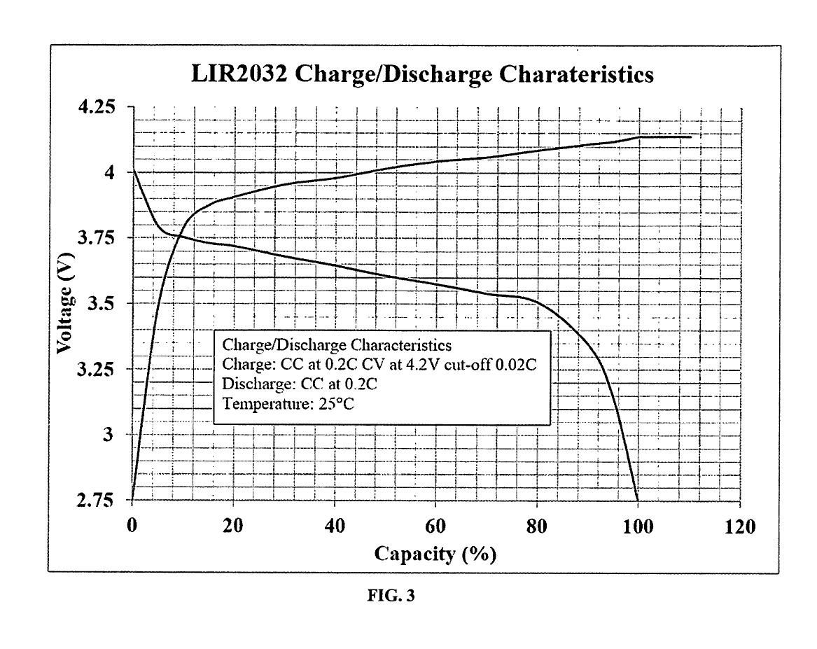

FIG. 3 shows the charge and discharge capacities over cell potential of the sample coin cell after 100 charge and discharge cycles. Reversible capacity of over 160 mAh·g⁻¹ can be maintained after over 100 cycles with above 80% depth of discharge.

The preferred embodiment of the present invention has been disclosed and illustrated. The invention, however, is intended to be as broad as defined in the claims below. Those skilled in the art maybe able to study the preferred embodiments and identify other ways to practice the invention those are not exactly as described herein. It is the intent of the inventors that variations and equivalents of the invention are with in the scope of the claims below and the description, abstract and drawings are not to be used to limit the scope of the invention.

The invention claimed is:

1. A method to prepare a composite anode for use in a lithium rechargeable battery using silicon particles from silicon kerf consisting of:
a. restricting the sizes of said silicon particles to a range of 10 nanometers and 10 micrometers with a preferred range from 50 nanometers to 500 nanometers, with a more preferred range from 100 nanometers to 300 nanometers,
b. separating said silicon particles from silicon kerf,
c. cleaning said silicon particles, and
d. forming said silicon particles with a restricted size into a composite matrix and attaching said composite matrix to a current collector for use as an anode in a lithium rechargeable battery.

2. A method according to claim 1 wherein said silicon particles are resized mechanically.

3. A method according to claim 1 wherein said silicon particles are separated from silicon kerf using filtration.

4. A method according to claim 1 wherein said silicon particles are separated from silicon kerf using centrifugation.

5. A method according to claim 1 wherein said silicon particles are cleaned to remove metallic or organic impurities.

6. A method according to claim 1 wherein said silicon particles are cleaned to remove surface oxide.

7. A method according to claim 1 wherein weight percent of said silicon particles is ranging from 0.5% to 50% with a preferred range from 5% to 40%, with a more preferred range from 15% to 30% based on the weight of the composite anode.

8. A method according to claim 1 wherein said silicon particles include silicon carbide.

9. A method according to claim 1 wherein said silicon particles include dopants such as boron, phosphorous, arsenic, or antimony, and combinations thereof.

10. A method to claim 1, wherein carbonaceous materials are from a variety of carbon sources, including graphite, carbon black, pitch or acetylene black.

11. A method according to claim 1 wherein polymer binder is polyvinylidene fluoride, sodium carboxymethyl cellulose or styrene-butadiene rubber.

12. A method according to claim 1 wherein said composite matrix is attached to a current collector for use as an anode for a lithium rechargeable battery.
